(19) United States
(12) Patent Application Publication
(10) Pub. No.: US 2014/0379481 A1
(43) Pub. Date: Dec. 25, 2014

(54) METHOD AND APPARATUS FOR TARGETING MESSAGES IN DESKTOP AND MOBILE APPLICATIONS

(71) Applicant: Adobe Systems Incorporated, San Jose, CA (US)

(72) Inventors: Anuj Gupta, New Delhi (IN); Anup, Noida (IN); Manish Kasat, Jodhpur (IN); Neeraj Bagga, Kanpur (IN)

(21) Appl. No.: 13/921,840

(22) Filed: Jun. 19, 2013

(51) Int. Cl. G06Q 30/02

(52) U.S. Cl. CPC G06Q 30/0269
USPC 705/14.66

(57) ABSTRACT

A computer implemented method and apparatus for targeting messages in desktop and mobile applications. The method comprises retrieving, on a user device, one or more policies for a software application; recording user behavior and application usage data during operation of the software application on the user device; determining whether one or more of said policies has been satisfied based on the recorded user behavior and application usage; and performing an action on the user device when it is determined that one or more of said policies has been satisfied.

### BACKGROUND OF THE INVENTION

1. Field of the Invention

Embodiments of the present invention generally relate to marketing and, more particularly, to a method and apparatus for targeting messages in desktop and mobile applications.

2. Description of the Related Art

An internet cookie is a message created by a website server and given to a user's website browser. The user's website browser stores the message in a text file. The message is then sent back to the website server each time the user's browser requests a page from the website server. Internet cookies provide online advertisers with accurate information about a website user. The online advertisers use the cookies to track user behavior and use the tracked behavior to show targeted messages of products and/or services that may be of interest to the user. When a user visits particular websites or reads particular content, advertisers try to serve ads to the user that match the user's content browsing preferences. However, the cookie based methods also invade a user's privacy. With cookies, online advertisers track user actions and build a profile of the user without the user's consent. The cookie will tell a web site who you are if you ever visit their site again. The cookie tracks and stores information about online orders placed by the user, web pages that have been visited, user ID's, and the like and use this information without the user's consent to target marketing messages to the user.

Therefore, there is a need for a method and apparatus for targeting messages in desktop and mobile applications.

### SUMMARY OF THE INVENTION

A method and apparatus for targeting messages in desktop and mobile applications substantially as shown in and/or described in connection with at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram of a system for targeting messages in desktop and mobile applications, according to one or more embodiments; and

FIG. 2 is a flowchart of a method for displaying targeted messages in desktop and mobile applications, as performed by the application of FIG. 1, according to one or more embodiments.

While the method and apparatus is described herein by way of example for several embodiments and illustrative drawings, those skilled in the art will recognize that the method and apparatus for targeting messages in desktop and mobile applications is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for targeting messages in desktop and mobile applications defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Embodiments of the present invention include a method and apparatus for targeting messages in desktop and mobile applications. When a desktop or mobile application launches, the embodiments retrieve one or more policies from a marketing server for an application. The policies apply sophisticated business logic to show targeted messages based on recorded user behavior data and product usage data. The policies may also define specific actions that are to be performed when the recorded data satisfies the policy. For example, a policy for ADOBE® READER® may dictate that if a user performs a “text copy” operation a predefined number of times in the same document, then display a message advertising the virtues of ADOBE® ExportPDF and provide a universal resource locator (URL) in the message where the user may purchase ADOBE® ExportPDF. Alternatively, the policy may dictate that if a user performs the “text copy” operation a predefined number of times in the same document, the user is automatically navigated to an online promotion website for ExportPDF.

The embodiments record data regarding product usage and user behavior within operation of the application. The recorded data is stored in a database as it is generated. The recorded data includes various events in the application including mouse selection or using a tool/feature, such as adding a comment, copying content, and the like. Applications events are also recorded, such as application crashes or updates, in addition to a number of times each event occurs within a day, week, month, or other predetermined time period. The recorded data also includes each type of document that is opened in the application and application specific information such as language, geography, and the like. After each event or piece of data is recorded, the embodiments determine from the currently accumulated recorded data, whether a policy has been satisfied that requires the display of a message or other action. The policy that is satisfied may be due to product usage, user behavior, or it may be that a predefined amount of time has passed since a last message was displayed.

Business logic defining the one or more policies is performed before a message is displayed. For example, if a message has already been displayed and the user deleted the message within a predefined period of time, for example, three seconds, the business logic determines that the user is uninterested in the message and a different message is displayed. Similarly, if a message was displayed to a user and the user followed the URL in the message, the business logic determines that the message is to not be displayed in the future and a different message is to be displayed.

Thus, the message is displayed or action is taken based on the satisfied policy.

Advantageously, marketers of desktop and mobile applications, such as ADOBE Systems Incorporated of San Jose, California, can have targeted messages within desktop and mobile applications displayed to users based on product usage and user behavior. Because the application retrieves the policy from the marketer, and no recorded data is sent to the marketer, there is no invasion of user privacy. No data is ever sent to the marketer and the marketer is never made aware of which messages are displayed to which users. Application scripting is used to create rich business policies. Sophisticated business logic enables using highly selective criteria in selecting an appropriate message or action for the desktop or mobile application user.

Various embodiments of a method and apparatus for targeting messages in desktop and mobile applications are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

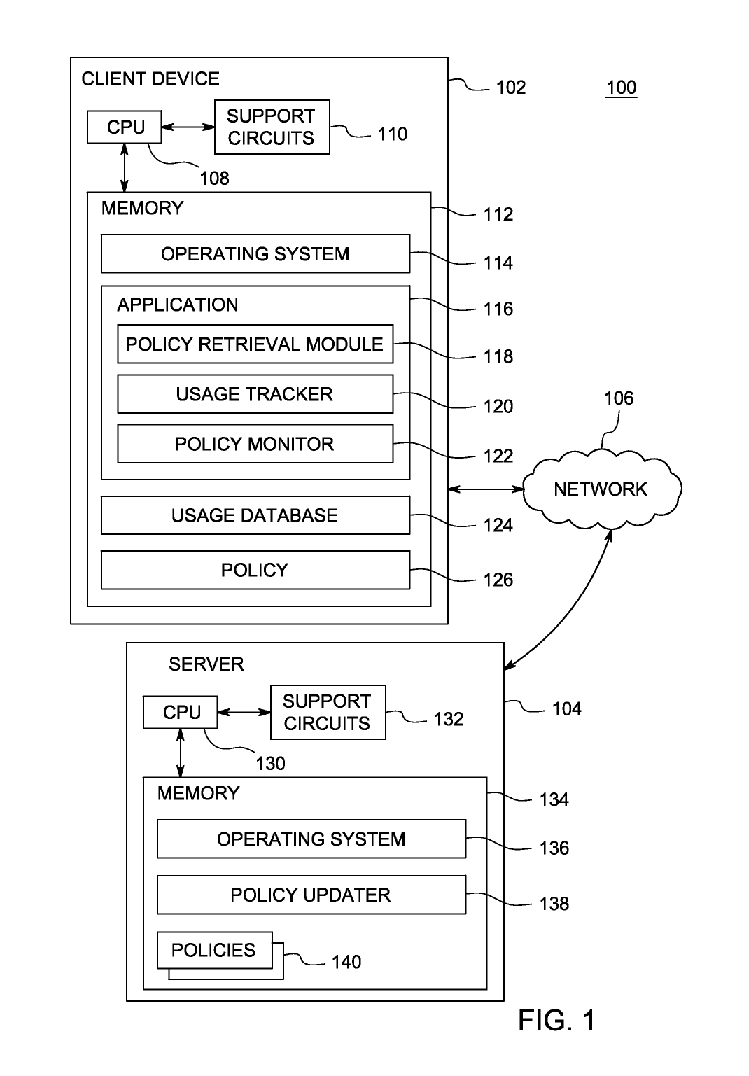

FIG. 1 is a block diagram of a system 100 for targeting messages in desktop and mobile applications, according to one or more embodiments. The system 100 includes a client device 102 and a server 104, communicatively coupled via a network 106. The client device 102 is a computing device, such as a desktop computer, laptop, tablet computer, and the like. The client device 102 includes a Central Processing Unit (CPU) 108, support circuits 110, and a memory 112. The CPU 108 may include one or more commercially available microprocessors or microcontrollers that facilitate data processing and storage. The various support circuits 110 facilitate the operation of the CPU 108 and include one or more clock circuits, power supplies, cache, input/output circuits, and the like. The memory 112 includes at least one of Read Only Memory (ROM), Random Access Memory (RAM), disk drive storage, optical storage, removable storage and/or the like.

The memory 112 includes an operating system 114, an application 116, a usage database 124, and a policy 126. The operating system 114 may include various commercially known operating systems. The application 116 may be any desktop or mobile software application, such as ADOBE® ACROBAT®, ADOBE® READER®, and the like, capable of interacting with a user of client device 102. It is noted that in some embodiments, portions of client device 102 may be implemented as a virtual machine without departing from the invention. The policy 126 may include a set of rules and a corresponding set of actions that are to be taken when the rules are met.

The server 104 is a computing device, such as a desktop computer, laptop, tablet computer, and the like. The server 104 may be a marketing server and includes a Central Processing Unit (CPU) 130, support circuits 132, and a memory 134. The CPU 130 may include one or more commercially available microprocessors or microcontrollers that facilitate data processing and storage. The various support circuits 132 facilitate the operation of the CPU 130 and include one or more clock circuits, power supplies, cache, input/output circuits, and the like. The memory 134 includes at least one of Read Only Memory (ROM), Random Access Memory (RAM), disk drive storage, optical storage, removable storage and/or the like. The memory 134 includes an operating system 136, a policy updater 138, and one or more policies 140. The operating system 136 may include various commercially known operating systems.

The network 106 includes a communication system that connects computers (or devices) by wire, cable, fiber optic and/or wireless link facilitated by various types of well-known network elements, such as hubs, switches, routers, and the like. The network 106 may be a part of the Intranet using various communications infrastructure, such as Ethernet, Wi-Fi, a personal area network (PAN), a wireless PAN, Bluetooth, Near field communication, and the like.

The policy updater 138 may create, modify, or delete one or more policies 140 at any time. The one or more policies 140 may be specific to a software application or the one or more policies 140 may be applicable to a plurality of software applications. The one or more policies 140 include one or more actions, to be taken when an event occurs within the application 116. For example, a policy may state: “show message for ExportPDF service after user copies text from a PDF five times.” In this example, the event is: “user copies text from a PDF five times”. The action is to display a message: “Do you want to use ExportPDF service?”

When the application 116 is launched, the policy retrieval module 118 retrieves one or more policies 140 for the application 116 from the server 104, and stores them as policy 126. The usage tracer 120 records product usage and user behavior data in the usage database 124 during operation of the application 116. After each recording of data, the policy monitor 122 determines whether any policies have been satisfied, and if so, performs an appropriate action as stated in the policy 126. The action may be displaying an advertising message, navigating the user to an online promotion website, opening an application feature for use in the application 116, and the like. The process iterates until the application 116 is closed (is no longer being operated by the user). At no time is a user's privacy violated. The policy monitor 122 monitors tracked behavior and performs an action based on the behavior, yet the user behavior is not sent back to the policy makers and/or online advertisers. The policy makers and/or online advertisers do not have access to the tracked behavior and further, have no way of knowing which advertising messages are displayed to which users. Hence, advertisers can target a user based on their behavior, yet the user's privacy is maintained.

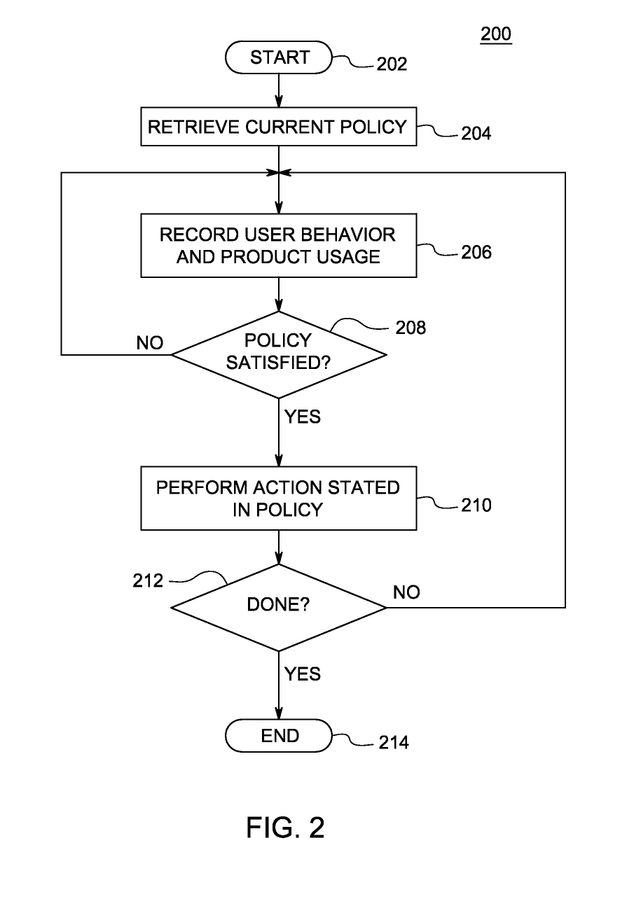

FIG. 2 is a flowchart of a method 200 for displaying targeted messages in desktop and mobile applications, as performed by the application 116 of FIG. 1, according to one or more embodiments. The method 200 records data regarding user behavior and product usage within operation of a software application and performs actions defined by policies associated with the software application. The method 200 starts at step 202 and proceeds to step 204.

At step 204, the method retrieves a current policy for a software application from a marketing server. The marketing server includes policies for one or more software applications. The policy includes one or more actions, to be taken when an event occurs within the software application. The policies may be changed at any time on the marketing server. When a user executes a software application, whether it be a desktop or a mobile application, the method 200 retrieves the current policy from the marketing server. In some embodiments, the method 200 sends a request for the current policy. In some embodiments, the method 200 determines whether the policy has changed since a previous execution of the software application and only requests the current policy, if the policy has changed.

The method 200 proceeds to step 206, where the method 200 records user behavior and product usage data during operation of the software application. The user behavior and product usage data may include mouse selection information, text copying information, information concerning adding comments, and the like. The method 200 stores each data item in a database during operation of the software application.

The method 200 proceeds to step 208, where the method 200 determines whether a policy has been satisfied during operation of the software application. This occurs each data item is stored in the database. For example, a policy may state: “display message for ExportPDF service after user copies text from PDF five times”. After the first instance of text copying is recorded by method 200 in the database, the policy in the current example is not satisfied. Not until a fifth text copying event is recorded is the policy satisfied. If the method 200 determines that a policy has not been satisfied, the method 200 proceeds to step 206 and iterates until a policy has been satisfied. In some embodiments, a policy states that after a predefined period of time without a satisfied policy, display a general advertising message.

If at step 208, the method 200 determines that a policy has been satisfied, the method 200 proceeds to step 210. At step 210, the method 200 performs the action stated in the policy. As stated in the current example, the policy may state: “display message for ExportPDF service after user copies text from PDF five times”. The method 200 may apply logic to the selection of the specific message that is displayed. For example, if a message for ExportPDF was previously displayed and promptly dismissed by the user, the method 200 may select a different message for ExportPDF that may be more enticing to the user or may include more information that addresses the user's behavior since the time the message was previously displayed.

The method 200 proceeds to step 212, where the method 200 determines whether a user is done operating the software application (i.e., has the user has closed the software application). If the method 200 determines that the user is not done, the method 200 proceeds to step 206 and iterates until the software application is closed. However, if the method 200 determines that the user is done, the method 200 proceeds to step 214 and ends.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java.®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method comprising:
retrieving, on a user device, one or more policies for a software application;
recording user behavior and application usage data during operation of the software application on the user device;
determining whether one or more of said policies has been satisfied based on the recorded user behavior and application usage; and
performing an action on the user device when it is determined that one or more of said policies has been satisfied.

2. The method of claim 1, wherein the one or more policies promote advertising from within the operating software application.

3. The method of claim 1, wherein the action is at least one of displaying an advertising message, navigating the user to an online promotion website, or opening an application feature for use in the application.

4. The method of claim 1, wherein one or more of said policies defines an action to be taken in the event one or more of said policies is satisfied.

5. The method of claim 4, wherein the action is replaced with a new action when the action has already been taken in the application.

6. The method of claim 1, wherein the recorded user behavior and application usage data is stored on the user device with the software application, and wherein no recorded user behavior nor application usage data is sent from the user device.

7. The method of claim 1, wherein determining occurs after each user behavior or application usage data is recorded.

8. An apparatus for targeting messages in desktop and mobile applications comprising:
a computer having one or more processors and further comprising:
an application for retrieving, on a user device, one or more policies for a software application;
a usage tracker for recording user behavior and application usage data during operation of the software application on the user device;
a policy monitor for determining whether one or more of said policies has been satisfied based on the recorded user behavior and application usage; and performing an action on the user device when it is determined that one or more of said policies has been satisfied.

9. The apparatus of claim 8, wherein the one or more policies promote advertising from within the operating software application.

10. The apparatus of claim 8, wherein the action is at least one of displaying an advertising message, navigating the user to an online promotion website, or opening an application feature for use in the application.

11. The apparatus of claim 8, wherein one or more of said policies defines an action to be taken in the event one or more of said policies is satisfied, and wherein the action is replaced with a new action when the action has already been taken in the application.

12. The apparatus of claim 8, wherein the recorded user behavior and application usage data is stored on the user device with the software application, and wherein no recorded user behavior nor application usage data is sent from the user device.

13. The apparatus of claim 8, wherein determining occurs after each user behavior or application usage data is recorded.

14. A non-transient computer readable medium for storing computer instructions that, when executed by at least one processor causes the at least one processor to perform a method for targeting messages in desktop and mobile applications comprising:
retrieving, on a user device, one or more policies for a software application;
recording user behavior and application usage data during operation of the software application on the user device;
determining whether one or more of said policies has been satisfied based on the recorded user behavior and application usage; and
performing an action on the user device when it is determined that one or more of said policies has been satisfied.

15. The computer readable medium of claim 14, wherein the one or more policies promote advertising from within the operating software application.

16. The computer readable medium of claim 14, wherein the action is at least one of displaying an advertising message, navigating the user to an online promotion website, or opening an application feature for use in the application.

17. The computer readable medium of claim 14, wherein one or more of said policies defines an action to be taken in the event one or more of said policies is satisfied.

18. The computer readable medium of claim 17, wherein the action is replaced with a new action when the action has already been taken in the application.

19. The computer readable medium of claim 14, wherein the recorded user behavior and application usage data is stored on the user device with the software application, and wherein no recorded user behavior nor application usage data is sent from the user device.

20. The computer readable medium of claim 14, wherein determining occurs after each user behavior or application usage data is recorded.
